(19) United States
(12) Patent Application Publication
(10) Pub. No.: US 2010/0283850 A1
(43) Pub. Date: Nov. 11, 2010

(54) SUPERMARKET VIDEO SURVEILLANCE SYSTEM

(76) Inventor: YANGDE LI, Dongguan (CN)

Correspondence Address: LEONG C. LEI, PMB # 1008, 1839 YGNACIO VALLEY ROAD, WALNUT CREEK, CA, 94598, US

(21) Appl. No.: 12/435,412

(22) Filed: May 5, 2009

(51) Int. Cl. H04N 7/18

(52) U.S. Cl. 348/143; 348/E07.09

(57) ABSTRACT

The video surveillance system contains a controller, a camera, a sensor, and an optical sensitization paper. The sensor and the optical sensitization paper are arranged at the same height. When an object is between the sensor and the optical sensitization paper, the sensor would send an alarm signal to the controller. The controller is to provide processing for the received signal. When it receives the alarm signal from the sensor, it triggers an alarm and sends an activation command to the camera. The camera, after receiving the activation command from the controller, starts video recording and sends the video data to the controller for showing on the display monitor, or output from the USB port, thereby preserving evidence to resolve any dispute.

### TECHNICAL FIELD OF THE INVENTION

The present invention generally relates to video surveillance, and more particularly to a video surveillance system for supermarkets or the like that have checkout counters.

### DESCRIPTION OF THE PRIOR ART

Supermarkets usually have some antitheft systems installed to prevent shoplifting. A common approach adopted by these systems is to apply magnetic stickers on the merchandises, and to install magnetic sensors at the supermarket exits. Only the merchandises that have been paid for and properly demagnetized at the checkout counter will not be sensed by the magnetic sensors and trigger an alarm. For example, the People's Republic of China Patent Application No. 98117004.8 teaches such a system.

However, a common excuse of the alleged customer is that the cashier at the checkout counter forgets to demagnetize or does not demagnetize appropriately. Without concrete evidence, it is difficult to tell whether the customer is telling the truth.

### SUMMARY OF THE INVENTION

Therefore, a novel video surveillance system is provided herein to obviate the foregoing shortcomings.

The video surveillance system contains a controller, a camera, a sensor, and an optical sensitization paper.

The sensor and the optical sensitization paper are arranged at the same height. When an object is between the sensor and the optical sensitization paper, the sensor would send an alarm signal to the controller.

The controller is to provide processing for the received signal. When it receives the alarm signal from the sensor, it triggers an alarm and sends an activation command to the camera.

The camera, after receiving the activation command from the controller, starts video recording and sends the video data to the controller.

Preferably, the sensor is one of an infrared sensor and a BOBcheck sensing device.

Preferably, there are one to three sensors.

Preferably, the system has a keyboard connected to the controller for configuring system parameters and to confirm and stop the alarm.

Preferably, the system has an AC (alternating current) power adaptor connected to the controller for providing 5V or 12V voltage.

Preferably, the system has a display monitor connected to the controller for showing the video data sent from the camera.

Preferably, the camera is a color CMOS (Complementary Metal-Oxide Semiconductor) camera.

Preferably, the controller provides an USB (Universal Serial Bus) port for data output.

Preferably, the controller provides a network port for connection with a network.

The video surveillance system, when receiving an alarm signal from the sensor, triggers an alarm and activates the camera. The video data is then sent to the controller and displayed on the display monitor, or output from the USB port, thereby preserving evidence to resolve any dispute.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing the video surveillance system according to the present invention.

FIG. 2 is a functional block diagram showing the controller of the video surveillance system of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

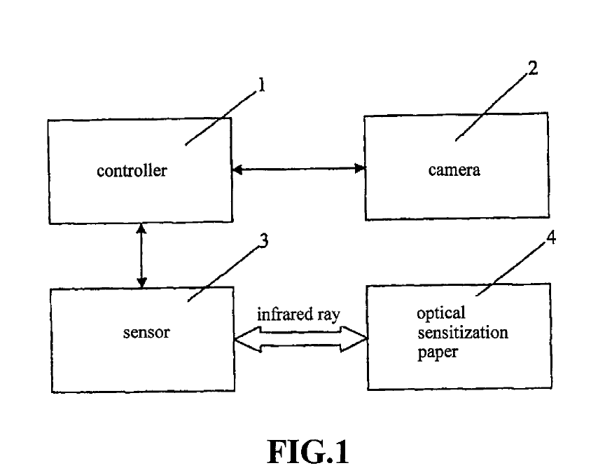

As shown in FIG. 1, a functional block diagram of the video surveillance system of the present invention contains a controller 1, a camera 2, a sensor 3, and an optical sensitization paper 4.

The sensor 3 and the optical sensitization paper 4 are arranged at the same height. When an object is between the sensor 3 and the optical sensitization paper 4, the sensor 3 would send an alarm signal to the controller 1. The controller 1 is to provide processing for the received signal. When it receives the alarm signal from the sensor 3, it triggers an alarm and sends an activation command to the camera 2. The camera 2, after receiving the activation command from the controller 1, starts video recording and sends the video data to the controller 1.

Preferably, the sensor 3 is one of an infrared sensor and a BOBcheck sensing device. Additionally, in order to enlarge the coverage area, one to three sensors 3 could be arranged at the same height.

Preferably, to facilitate the setting of the system parameters, the video surveillance system has a keyboard connected to the controller 1 for configuring system parameters. The keyboard is also used to confirm and stop the alarm.

Preferably, the video surveillance system is operated from a DC (direct current) voltage. Therefore, an AC (alternating current) power adaptor connected to the controller 1 is provided for supplying 5V or 12V DC voltage.

Preferably, the video surveillance system has a display monitor connected to the controller 1 for showing the video data sent from the camera 2.

Preferably, the camera 2 is a color CMOS camera.

Preferably, the controller 1 provides an USB port for data output.

Preferably, the controller 1 provides a network port for connection with a network.

The video surveillance system is installed and operated as follows. The sensor 3 is installed on a checkout counter's front side facing the customer. The optical sensitization paper 4 is installed on a shopping cart. The sensor 3 and the optical sensitization paper 4 are positioned at the same height. At that height, a hole of 12 mm aperture is drilled on the front side of the checkout counter. Inside the checkout counter and behind the 12 mm hole, a support frame is installed so that the sensor 3 could be placed. The optical sensitization paper 4 reflects the infrared from the sensor 3. When a certain object is between the sensor 3 and the optical sensitization paper 4, the sensor 3 notifies the controller 1 to trigger alarm. On the same side of the checkout counter, a hole of 50 mm is drilled for the camera 2 which should have a clear view of the shopping cart when the sensor 3 is working. To make sure that the camera 2 is positioned properly, the camera 2 and the display monitor are connected to the controller 1 and the video surveillance system is powered up. By viewing what is captured by the camera 2 on the display monitor, the proper location for the camera 2 could be determined.

All the components of the video surveillance system are positioned by undry adhesives. The installation is therefore very convenient as there are no bolts and nuts.

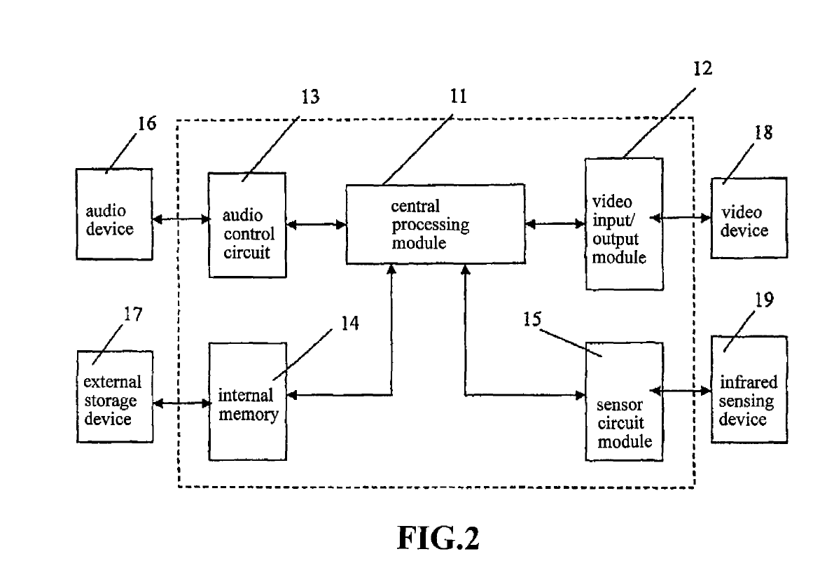

As shown in FIG. 2, the controller 1 contains a central processing module 11, video input/output module 12, sensor circuit module 15, internal memory 14, and audio control circuit 13. An infrared sensing device 19 is connected to the central processing module 11 via the sensor circuit module 15. A video device 18 is connected to the central processing module 11 via the video input/output module 12. An audio device 16 is connected to the central processing module 11 via the audio control circuit 13. An external storage device 17 is connected to the central processing module 11 via the internal memory 14.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A video surveillance system for supermarkets, comprising a controller, a camera, a sensor, and an optical sensitization paper;
wherein said sensor and said optical sensitization paper are arranged at the same height; when an object is between said sensor and said optical sensitization paper, said sensor sends an alarm signal to said controller;
said controller is to provide processing to received signals; when said alarm signal is received from said sensor, said controller triggers an alarm and sends an activation command to said camera; and
said camera, after receiving said activation command from said controller, starts video recording and sends video data to said controller.

2. The video surveillance system according to claim 1, wherein said sensor is one of an infrared sensor and a BOBcheck sensing device.

3. The video surveillance system according to claim 1, wherein there are one to three sensors.

4. The video surveillance system according to claim 1, further comprising a keyboard connected to said controller for configuring system parameters and to confirm and stop said alarm.

5. The video surveillance system according to claim 1, further comprising an AC power adaptor connected to said controller for providing 5V or 12V DC voltage.

6. The video surveillance system according to claim 1, wherein further comprising a display monitor connected to said controller for showing said video data sent from said camera.

7. The video surveillance system according to claim 1, wherein said camera is a color CMOS camera.

8. The video surveillance system according to claim 1, wherein said controller provides an USB port for data output.

9. The video surveillance system according to claim 1, wherein said controller provides a network port for connection with a network.
